(19) United States
(12) Patent Application Publication
(10) Pub. No.: US 2016/0245438 A1
(43) Pub. Date: Aug. 25, 2016

(54) DEVICE FOR DRAINING LIQUIDS AND FATS FROM CHAMBERS OF COOKING OVENS, PARTICULARLY OVENS FOR FOOD USE

(71) Applicant: UNOX S.p.A., CADONEGHE (PD) (IT)

(72) Inventor: Enrico FRANZOLIN, CADONEGHE (PD) (IT)

(73) Assignee: UNOX S.p.A., CADONEGHE (PD) (IT)

(21) Appl. No.: 15/050,960

(22) Filed: Feb. 23, 2016

(30) Foreign Application Priority Data
Feb. 24, 2015 (IT) 202015000006785

(51) Int. Cl. F16L 29/00; F16K 31/06

(52) U.S. Cl. CPC F16L 29/007; F16K 31/06

(57) ABSTRACT

A device for draining liquids and fats from the cooking chambers of ovens includes a three-way pipe element, with a first portion of pipe extending between a first and a second port, these ports being axially opposed, and a second portion extended to form a branch from the first portion and rotated relative to the latter, having a third port suitable for connection to the liquid drain of the environment in which the oven is installed, the pipe element being connected in fluid communication, via the first port, with a drainage aperture of the cooking chamber of the oven. The device further includes a two-way valve provided downstream of the second port of the pipe element, for selectively shutting off or freeing the flow passage through the second port.

### FIELD OF THE INVENTION

The present invention relates to a device for draining liquids and fats from cooking chambers of ovens, particularly in ovens for food use.

### BACKGROUND

In this specific technical field there is a known way of providing a drainage line for liquids from cooking chambers of ovens, in particular in ovens for food use of the professional type, such a line being suitable for draining liquids and fats generated during cooking, as well as washing liquids used in oven maintenance cycles.

During the operation of an oven, cooking liquids and fats are generally deposited in the cooking chamber, these liquids and fats being typically carried along the drainage line of the oven and collected in suitable containers or tanks for proper disposal, thus preventing the discharge of cooking fats into the conventional sewerage system. However, the liquids generated in the process of washing the cooking chamber are generally sent to the sewerage system via the oven drainage line. It is therefore necessary to control the drainage correctly, according to the nature of the liquids generated in the phases of operation and maintenance of the oven, where cooking fats may or may not be present.

### SUMMARY

The main object of the invention is to provide a device for draining liquids and fats from cooking chambers of ovens which is structurally and functionally designed for ease of drainage and cleaning, simplicity of construction at low cost, and efficient maintenance, relative to the known solutions.

This object and others which will be more fully apparent below are achieved by means of a drainage device made in accordance with the claims below.

### BRIEF DESCRIPTION OF THE DRAWINGS

Other features and advantages of the invention will become clear from the following detailed description of a preferred example of embodiment thereof, illustrated purely for guidance and in a non-limiting way with reference to the attached drawings, in which:

FIG. 1 is a schematic view in front elevation of a device according to the invention,

FIG. 2 is a perspective view of the device of FIG. 1,

FIG. 3 is a perspective view on an enlarged scale of a detail of the device of the preceding figures, and

FIG. 4 is a partial view on an enlarged scale of a further detail of FIG. 3.

### DETAILED DESCRIPTION OF THE PREFERRED EMBODIMENTS

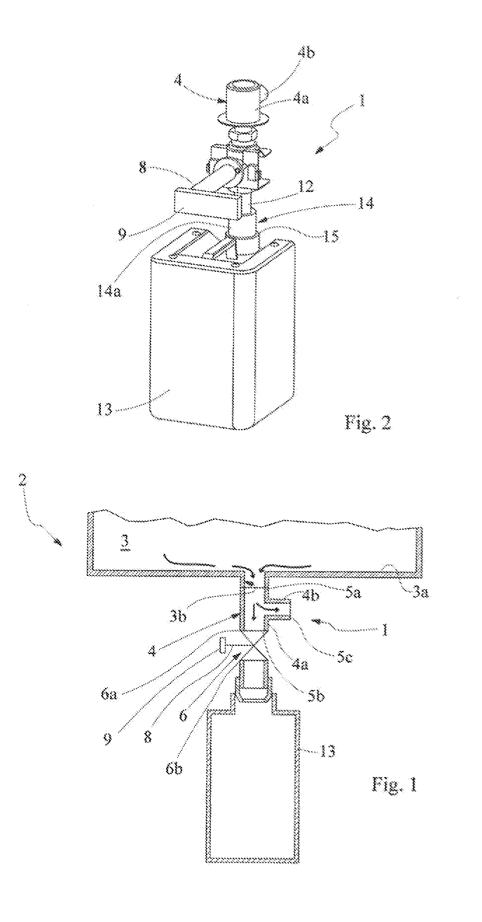

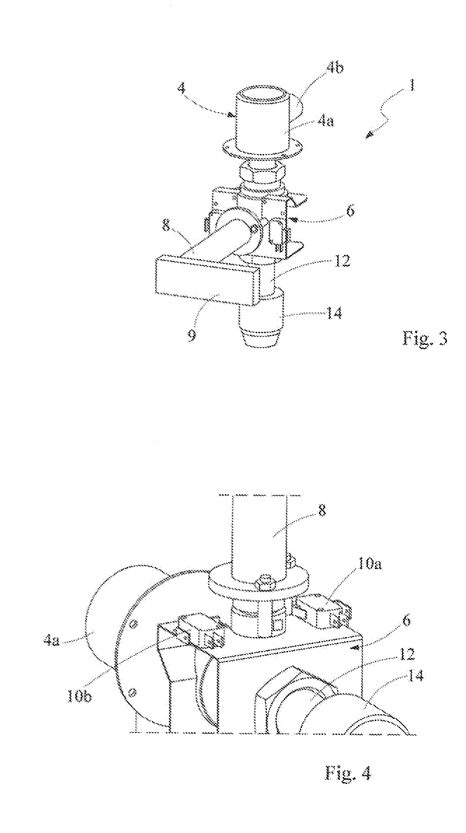

With reference to the aforesaid drawings, the number 1 indicates the whole of a device for draining liquids and fats from a cooking chamber of an oven 2 for food use, made according to the invention, the oven being only partially shown in FIG. 1.

The number 3 indicates the cooking chamber of the oven, which is shown only partially and schematically, the bottom surface 3a of which is provided with an aperture 3b connected in fluid communication with the drainage device 1.

The device comprises a three-way pipe element 4, with a first portion 4a of pipe extending between a pair of axially opposed end ports 5a, 5b and a second portion 4b extending as a branch from the portion 4a, being rotated relative to the latter and carrying an end port 5c. The pipe element 4 is conveniently T-shaped, with the portions 4a, 4b placed perpendicularly to one another.

The pipe element 4 is also designed to be connected to the drain of the cooking chamber, in which the port 5a is connected in a fluid-tight way and in fluid communication with the drainage aperture 3b of the cooking chamber, so that all the liquids and fats collected on the bottom 3a of the chamber are directed to the drainage via the port 5a of the T-shaped pipe.

According to a main distinctive feature of the invention, provision is made for the pipe element 4 to be designed for connection to the drain of the cooking chamber with the axial portion 4a orientated in the vertical direction of the gravitational flow of liquids from the drainage aperture of the cooking chamber, as clearly shown in FIG. 1.

The number 6 indicates a two-way valve means, made in the form of an on-off shut-off valve for example, provided on the drainage line downstream of the port 5b of the pipe element 4 relative to the axial direction of drainage of the flow. The valve 6 can selectively shut off or free the flow passage through the second port 5b of the T-shaped element 4, and is provided with a valve body delimiting a conduit in which is provided a shutter (not shown) of a conventional type (such as a ball type). Preferably, the valve conduit extends axially between the two opposing end paths or sections 6a, 6b, in vertical alignment with the portion 4a of pipe 4.

The shutter can be moved between an operating position in which the flow is shut off between the two paths of the valve means 6 and an inoperative position in which the flow between these paths is allowed, a control rod 8 being associated with the shutter to operate the shutter in angular rotary travel between the two aforesaid positions. An operating member 9 is provided at the free end of the rod 8 for the manual rotation of the rod.

A pair of limit microswitches 10a, 10b are provided on the device, outside the valve body 6, to interact with the actuator rod 8 at the operative end position (with the valve open) and at the opposite inoperative end position of the shutter (with the valve closed), respectively.

In a variant embodiment of the invention, the valve means 6 may be of the power-operated type, or may be made in the form of a solenoid valve.

Downstream of its outlet section 6b, the valve body 6 is connected to a terminal tubular portion 12, designed to connect the drainage device in fluid communication with a collecting container or tank, indicated by 13. On the portion 12, which is also elongated in rectilinear prolongation of the conduit 6 and of the portion 4a of the pipe 4, there is slidably fitted a sleeve formation 14, the outer shell 14a of which can be inserted at least partially and sealingly into a mouth 15 of the tank. The sleeve formation 14 is manually movable (its weight is sufficient to make it descend into the closing position and to keep it there) along the tubular portion 12, between an inserted position of sealed coupling with the mouth 15 of the tank (acting as a “plug”) and a position of separation from the mouth, for freeing the movement of the tank relative to the drainage device to allow the tank to be emptied. In this position, it should be noted that the tank 13 can be moved transversely relative to the vertical direction without interference with the terminal part of the tubular portion 12.

The operation of the device is as follows.

During the operation of the oven, in the execution of the specified cooking cycles, when the cooking fats and liquids are to be drained from the cooking chamber, the valve 6 is made to open so that the liquids and fats flow vertically downwards by gravity and are collected in the tank 13 (and therefore do not enter the portion 4b of the T-shaped pipe).

In the phases of washing the cooking chamber, however, the valve is made to close, causing the port 5b of the T-shaped pipe to be shut off. When the washing liquids (water, detergent and washing residues) have been directed to the drain of the cooking chamber they are then conveyed along the portion 4b of the T-shaped pipe, which is conveniently connected to the conventional sewerage system.

By actuating the microswitches 10a, 10b it is also possible to signal the operating state (open or closed, respectively) of the valve to the oven control logic, for the purpose of controlling consent to the drainage of the liquids and fats from the cooking chamber towards the tank or towards the conventional sewerage system.

According to another distinctive feature of the invention, the drainage device can be made as a unit which can be handled individually for easy connection to the drain of the oven cooking chamber. In one embodiment, the drainage device is made in the form of a kit of separate parts; in other words, all of its components are supplied loose so that they can be assembled, for example, by the oven installer.

Alternatively, the drainage device can be made in an integrated form; in other words, a structure is supplied with the whole drainage system installed, on which the oven is positioned and in which it is simply necessary to make the connections to the oven drain and to the sewerage system.

Thus the invention achieves the proposed objects while yielding numerous advantages by comparison with the known solutions.

A principal advantage lies in the fact that the device according to the invention provides substantially vertical drainage of the cooking fats, allowing easy cleaning, and making the device less subject to clogging.

Another advantage lies in the simplification of construction, which reduces production costs.

What is claimed is:

1. A device for draining liquids and fats from chambers of cooking ovens comprising a three-way pipe element, with a first portion of pipe extending between a first and a second port, these ports being axially opposed, and a second portion extended to form a branch from the first portion and rotated relative to the latter, said second portion having a third port suitable for connection to a liquid drain of the environment in which the oven is installed, wherein the pipe element can be connected in fluid communication, via the first port, with a drainage aperture of the cooking chamber of the oven; and wherein said device further comprises a two-way valve means provided downstream of the second port of the pipe element, for selectively shutting off or freeing the flow passage through the second port.

2. The device according to claim 1, wherein the pipe element is T-shaped, with the first and second pipe portions directed perpendicularly to one another.

3. The device according to claim 2, wherein the pipe element is configured for connection to the drain of the cooking chamber with the first portion of pipe orientated in the vertical direction of the gravitational flow of liquids and fats drained from the cooking chamber.

4. The device according to claim 1, wherein the valve means comprises a shutter element which is movable between an operating position in which the flow is shut off between the two paths of the valve means and an inoperative position in which the flow between these paths is allowed, and a control rod associated with the shutter to control the shutter in its angular rotary travel between the two aforesaid positions, limit microswitches being provided to interact with the actuator rod in the operating position and the inoperative position, respectively, of the shutter.

5. The device according to claim 1, wherein the valve means is manually operable, with an operating member associated with the rod for manual operation by rotation of the shutter between the two positions.

6. The device according to claim 1, wherein the valve means is power-operated, or is configured as a solenoid valve.

7. The device according to claim 1, further comprising a tubular portion, connected downstream of the valve means relative to the direction of drainage of the liquids, for draining liquids into a collecting container or tank.

8. The device according to claim 7, further comprising a sleeve formation fitted slidably on the tubular portion, the outer shell of this formation being sealingly insertable into the mouth of the tank, the sleeve being movable between an inserted position, in which it is sealingly coupled to the mouth of the tank, and a position of separation from the mouth, for freeing the movement of the tank for the purpose of emptying the latter.

9. The device according to claim 1, configured as a unit which can be handled individually and which can be connected to the aperture for the drainage of liquids and fats from the cooking chamber of the oven.
